(19) United States
(12) Patent Application Publication
(10) Pub. No.: US 2025/0273807 A1
(43) Pub. Date: Aug. 28, 2025

(54) BATTERY AND BATTERY SYSTEM INCLUDING PRESSURE VESSEL

(71) Applicant: Schaeffler Technologies AG & Co. KG, Herzogenaurach (DE)

(72) Inventors: Timothy CHAMBERLAIN, Wooster, OH (US); Kewei LIU, Wadsworth, OH (US); Matthew WISE, Hamilton, OH (US)

(21) Appl. No.: 18/584,149

(22) Filed: Feb. 22, 2024

(51) Int. Cl. H01M 50/367; H01M 10/04; H01M 50/107; H01M 50/121; H01M 50/136; H01M 50/152

(52) U.S. Cl. CPC H01M 50/367; H01M 10/0431; H01M 50/107; H01M 50/121; H01M 50/136; H01M 50/152; H01M 2300/0065

(57) ABSTRACT

A battery includes a tubular battery cell including an anode, a cathode and a solid electrolyte. The battery cell defines a central through hole. The battery further includes a container. The battery cell is inside of the container. The container includes a fluid inlet configured to provide fluid to the central through hole and a fluid outlet configured to receive fluid from the central through hole.

### TECHNICAL FIELD

The present disclosure relates generally to solid state electrolyte batteries.

### BACKGROUND

Solid state electrolyte battery cells require a different environment than liquid electrolyte batteries. Accordingly, there is a need for an improved battery design.

### SUMMARY

A battery includes a tubular battery cell including an anode, a cathode and a solid electrolyte. The battery cell defines a central through hole. The battery further includes a container. The battery cell is inside of the container. The container includes a fluid inlet configured to provide fluid to the central through hole and a fluid outlet configured to receive fluid from the central through hole.

In examples, the battery cell has a jelly roll configuration.

In some aspects, the techniques described herein relate to a battery further including a flexible housing inside the container surrounding the battery cell, the flexible housing configured for allowing the battery cell to radially expand and contract within the flexible housing.

In examples, the flexible housing is a bag an internal polypropylene shell formed of a first polymer and an external shell formed of a second polymer.

In examples, the flexible housing is oversized with respect to the battery cell to allow for up to 10% expansion of the battery cell during charge and/or discharge of the battery cell.

In examples, an outer circumferential surface of the battery cell and an inner circumferential surface of a tubular section of the container define a tubular space therebetween to allow gas to flow outside of the outer circumferential surface of the battery cell to generate a radially inward force on the outer circumferential surface of the battery cell.

In examples, the battery further includes an internal retainer inside the container and fixed to a first longitudinal end of the battery cell, the internal retainer including a central hole therein aligned with the central through hole of the battery cell to cause fluid flowing from the fluid inlet to the fluid outlet to pass through the central hole of the internal retainer.

In examples, the container includes a can and a lid fixed to the can, the can including the tubular section, the internal retainer being physically connected to the lid and held in place within the can by the lid.

In examples, a radially extending section of the can defines a first longitudinal end of the container and the lid defines a second longitudinal end of the container, the lid including the fluid outlet, the radially extending section of the can including the fluid inlet.

In examples, the radially extending section of the can includes an axially extending centering part protruding into the central through hole of the battery cell at a first longitudinal end of the battery cell.

In examples, the internal retainer includes an axially extending centering part protruding into the central through hole of the battery cell at a second longitudinal end of the battery cell.

In examples, the internal retainer is electrically connected to the lid and electrically connects a first lead of the battery cell to the lid.

In examples, the can is electrically connected to a second lead of the battery cell.

In examples, the first lead is positive and the second lead is negative.

In examples, the lid is configured to provide fluid flow channels between the lid and the internal retainer for fluid to pass from the central through hole of the battery cell to the tubular space.

A battery assembly is also provided that includes at least two of the batteries. At least one of the batteries being an upstream battery with respect to a fluid flow and at least one of the batteries being a downstream battery with respect to the fluid flow. The central through holes of the at least upstream battery and the at least one downstream battery are aligned with each other and the fluid inlet of one of the at least one downstream battery is connected to the fluid outlet of the at least upstream battery.

A battery system is also provided including the battery assembly; and a pressurization system for conveying compressed gas into the batteries to generate a force on the battery cells for maintaining uniform pressure on each battery cell.

A method of constructing a battery is also provided. The method includes inserting a tubular battery cell into an open end of a can such a tubular space is present between an outer circumferential surface of the battery cell and an inner circumferential surface of the can, a first longitudinal end of the battery cell facing a radially extending end section of the can, the radially extending end section of the can including a fluid inlet configured to provide fluid to a central through hole of the battery cell, the battery cell including an anode, a cathode and a solid electrolyte; installing an internal retainer onto a second longitudinal end of the battery cell; and connecting a lid to the open end of the can such that the lid is electrically connected to the internal retainer during operation of the battery, the lid including a fluid outlet configured to receive fluid from the central through hole.

### BRIEF DESCRIPTION OF THE DRAWINGS

The present disclosure is described below by reference to the following drawings, in which:

FIG. 1 shows a perspective view of a battery according to the present disclosure;

FIG. 2 shows a cross-sectional view of the battery along 2-2 in FIG. 1;

FIG. 3 shows a cross-sectional view of the battery along 3-3 in FIG. 1;

FIG. 4 shows a cross-sectional perspective view of the battery of FIG. 1;

FIG. 5 shows a perspective view of the battery shown in FIG. 1 with the container omitted;

FIG. 6 shows a partial cross-sectional view of a tubular battery cell having a jelly roll configuration;

FIG. 7 shows the tubular battery cell of FIG. 6 inside a flexible housing;

FIG. 8 schematically shows a battery assembly including multiple batteries connected together;

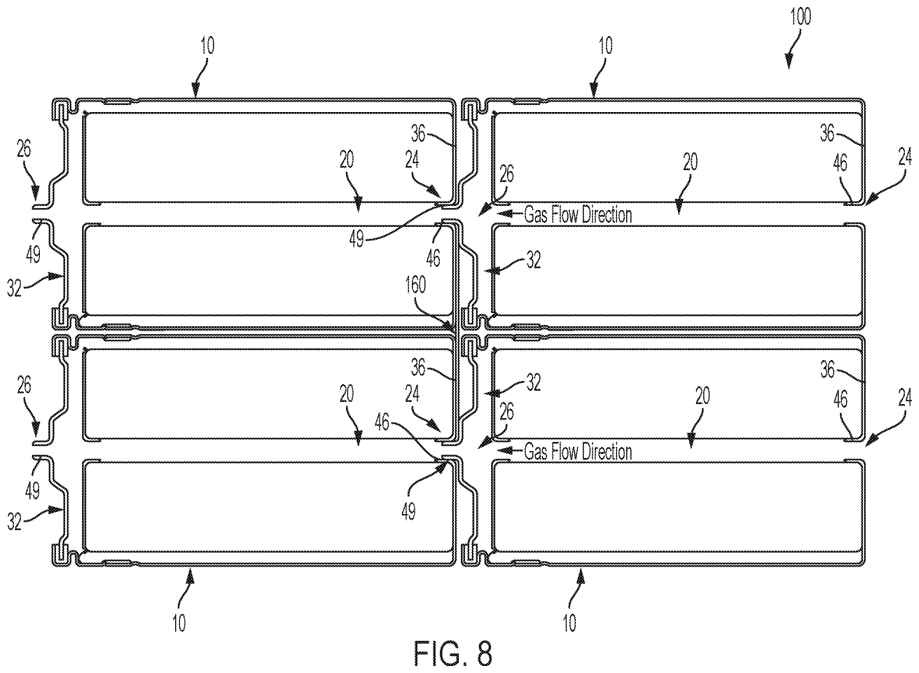

FIG. 9 shows a system for providing compressed and heated fluid to the battery assembly of FIG. 6.

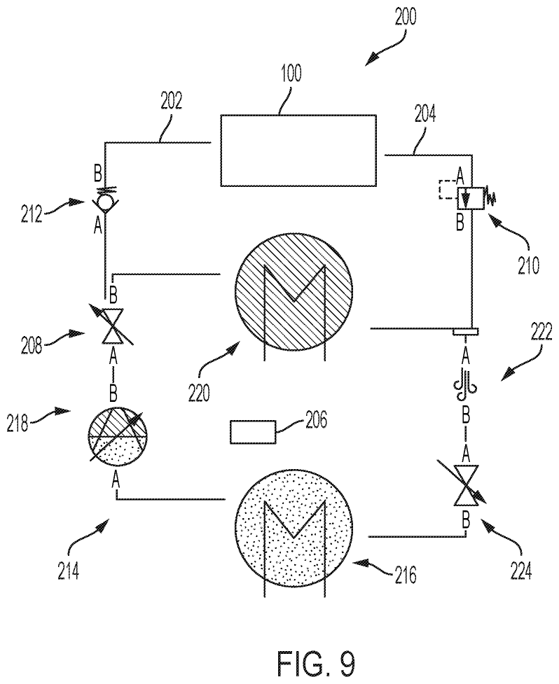

### DETAILED DESCRIPTION

Solid-state battery cells can require large pressures to maintain contact between the active materials of the anode and cathode and the electrolyte so that ion exchange is possible with the required contact area. Additionally, higher operating temperatures can also be also required. The present disclosure provides a battery and a battery system in which a battery cell can be compressed and heated during operation. The present disclosure allows compressed and heated CO₂ gas, to apply pressure and temperature to a tubular battery cell by allowing the gas around the battery cell to compress the battery cell in a controlled format. As such, the interior design of the battery includes fluid flow chambers that allow the gas to heat and pressurize the tubular battery cell so as to maintain even compressive pressure through the tubular battery cell. Furthermore, the battery is designed so that a system can pressurize and flow gas from one battery to the next using a series connection for the gas and electrical connections.

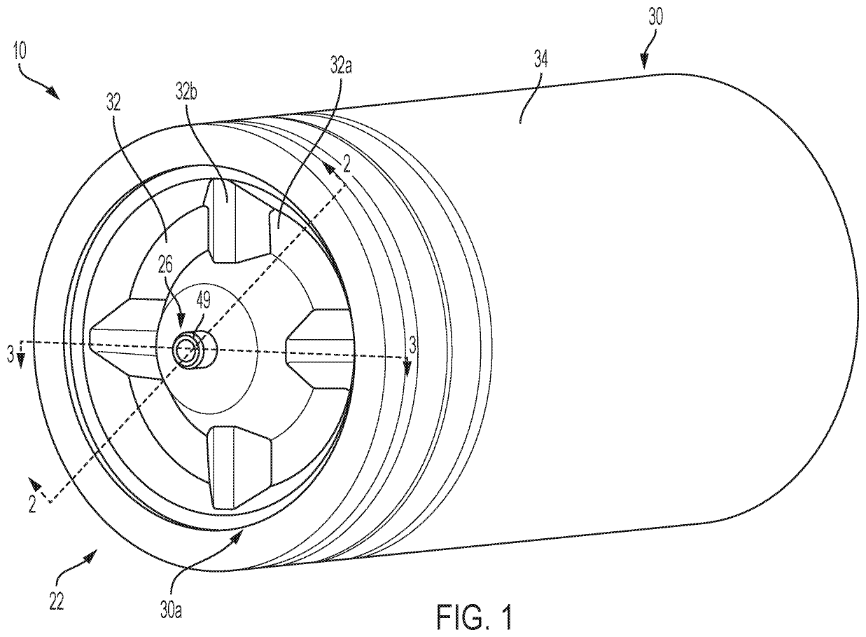

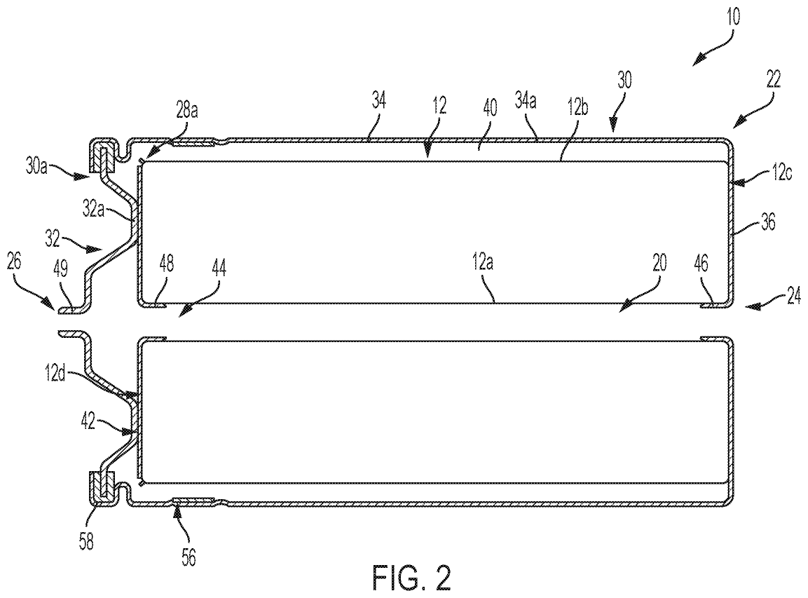

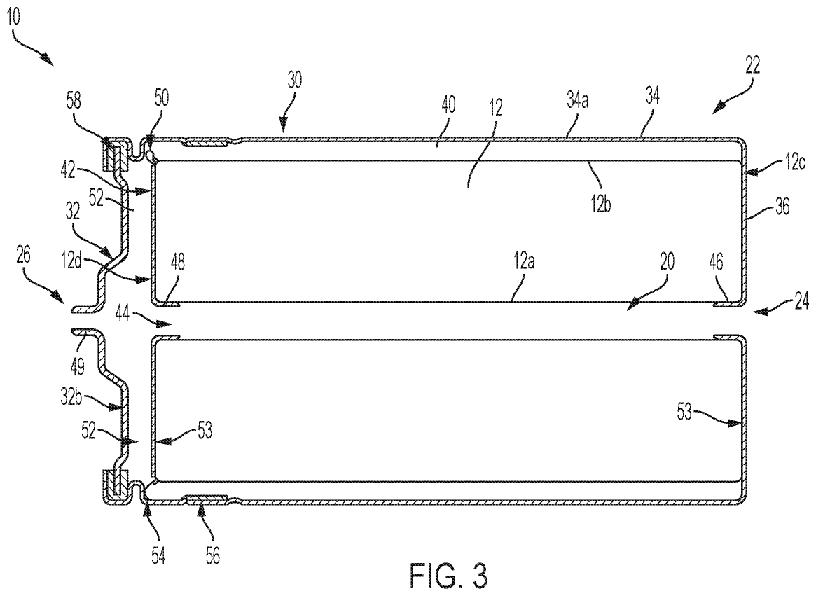

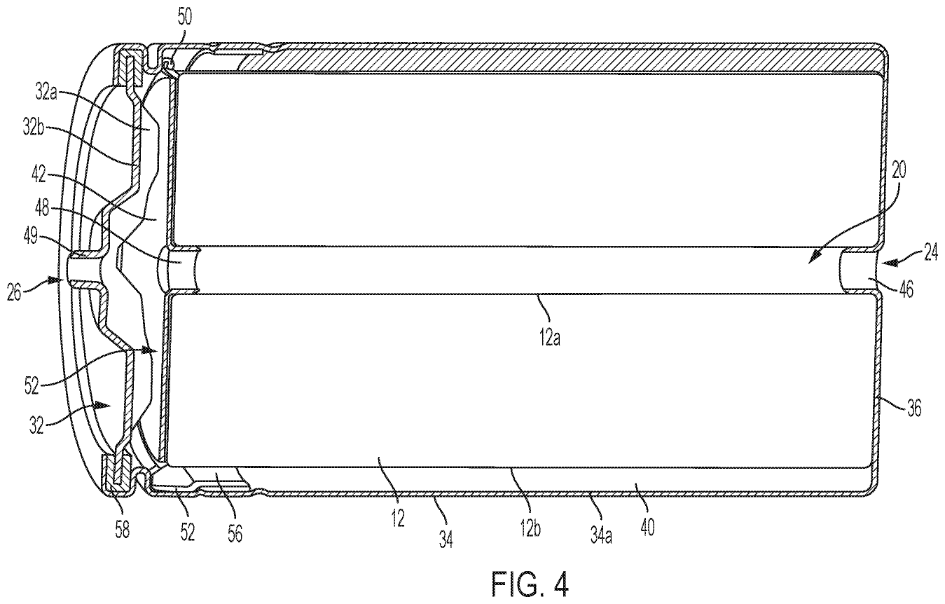

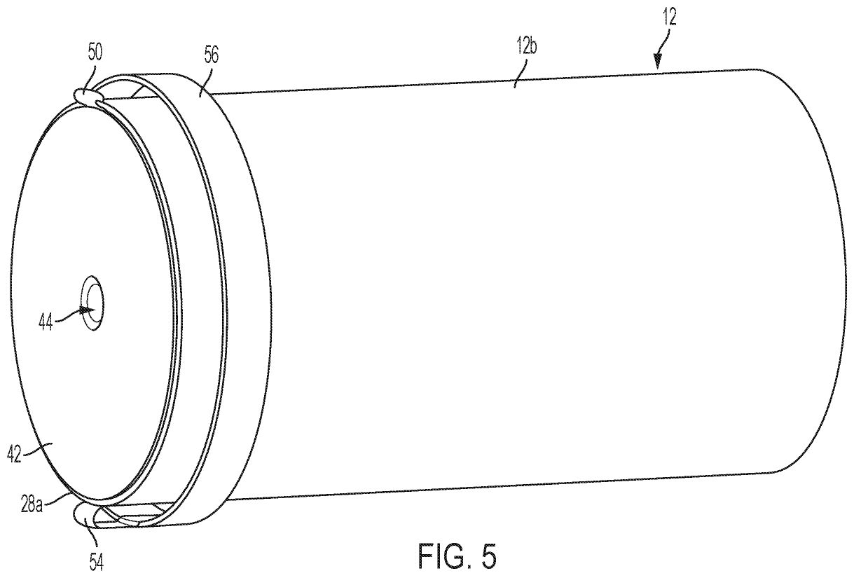

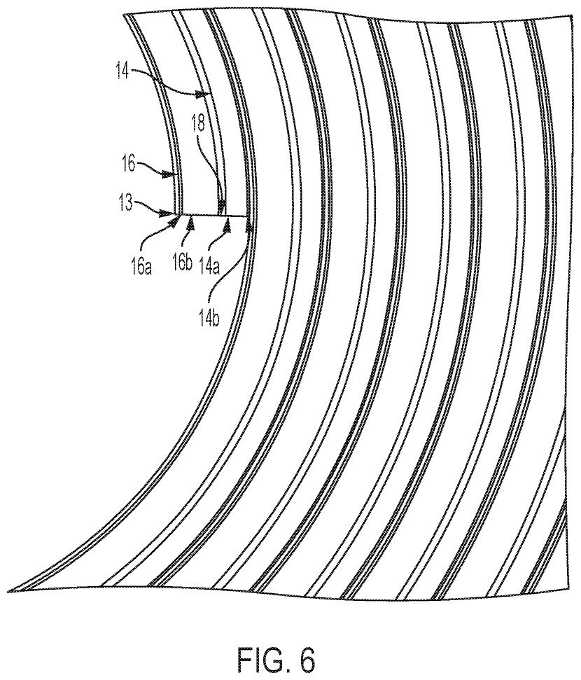

FIGS. 1 to 7 show different views of a battery 10. Battery 10 includes a tubular battery cell 12 including an anode 14, a cathode 16 and a solid electrolyte 18 (FIG. 6). The battery cell 12 defines a central through hole 20. Battery 10 further includes a container 22, and the battery cell 12 is inside of the container 22. The container 22 includes a fluid inlet 24 configured to provide fluid to the central through hole 20 and a fluid outlet 26 configured to receive fluid from the central through hole 20. Hole 20 is defined by an inner circumferential surface 12a of battery cell 12.

As illustrated in FIG. 6, battery cell 12 has a jelly roll configuration, including a strip of battery material rolled into a tubular form. The strip of battery material includes a plurality of layers, each extending an entirety of the length of the strip. Defining an inner circumferential surface of battery cell 12 is a separator material 13, with cathode 16 contacting an outward facing surface of separator material 13. Cathode 16 is formed by a cathode current collector foil 16a that directly contacts an outward facing surface of separator material 13 and a cathode material 16b directly contacting an outward facing surface of cathode current collector foil 16a. Next, solid electrolyte 18 directly contacts an outward facing surface of cathode material 16b, and then anode 14 contact an outward facing surface of solid electrolyte 18. Anode 14 is formed by an anode material 14a that directly contacts an outward facing surface of solid electrolyte 18 and an anode current collector foil 14b directly contacting an outward facing surface of anode material 14a.

The solid electrolyte 18 can be for example formed of a flexible material, which can for example be a polymer. The anode material 14a can be for example formed of graphite, silicon graphite mix, lithium metal, or lithium-titanium-oxide. The cathode material 16b can be for example formed of lithium nickel cobalt manganese oxide (NMC), lithium iron phosphate (LFP), lithium manganese oxide (LMO).

As discussed further below, the fluid can be a gas. In one example, the gas is compressed CO₂.

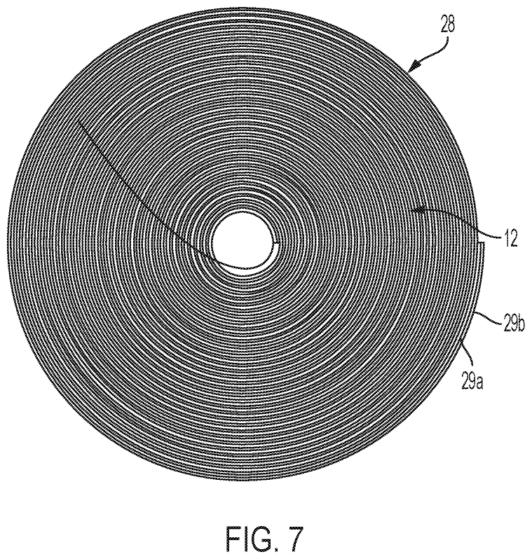

As illustrated in FIG. 7, battery 10 further includes a flexible housing 28 inside the container 12 surrounding the battery cell 12. The flexible housing 28 is configured to allow the battery cell 12 to radially expand and contract within the flexible housing 28. The flexible housing 28 also provides protection from the gas for the active materials of cell 12 as well as electrical isolation from the container 22. The flexible housing 28 can be a bag which has an internal shell 29a formed of a first polymer and an external shell 29b formed of a second polymer. Housing 28 can be sealed at a seam 28a on an outer circumferential corner of housing 28. The first polymer can be a polypropylene and the second polymer can be a polyimide, a polycarbonate, or a polysulfone. The flexible housing 28 can be oversized with respect to the battery cell 12 to allow for up to 10% expansion of the battery cell 12 during charge and/or discharge of the battery cell 12.

Container 22 can include a can 30 including an open end 30a and a lid 32 closing the open end 30a. Can 30 includes a tubular section 34 and a radially extending section 36. Radially extending section 36 closes a first longitudinal end of the tubular section 34 and lid 32 closes a second longitudinal end of the tubular section 34. Radially extending section 36 includes fluid inlet 24 and lid 32 includes fluid outlet 26. Further, a first longitudinal end 12c of the battery cell 12 is fixed to radially extending section 36.

An outer circumferential surface 12b of battery cell 12, more specifically of flexible housing 28, and an inner circumferential surface 34a of tubular section 34 defines a tubular space 40 therebetween to allow gas to flow outside of the outer circumferential surface 12b to generate a radially inward force on the outer circumferential surface 12b.

Battery 10 further includes an internal retainer 42 inside the container 12 that is fixed to a second longitudinal end 12d of the battery cell 12. The internal retainer 42 includes a central hole 44 therein aligned with the central through hole 20 of the battery cell 12 to cause fluid flowing from the fluid inlet 24 to the fluid outlet 26 to pass through the central hole 44 of the internal retainer 42. The internal retainer 42 is physically connected to the lid 32 and held in place within the can 30 by the lid 32.

The radially extending section 36 of the can 30 includes an axially extending centering part 46 protruding into the central through hole 20 of the battery cell 12 at a first longitudinal end of the battery cell 12. Similarly, the internal retainer 42 includes an axially extending centering part 48 protruding into the central through hole 20 of the battery cell 12 at a second longitudinal end of the battery cell 12. Centering parts 46, 48 thus act on opposite longitudinal ends of hole 20 to center battery cell 12 within container 22. Each of radially extending section 36 and internal retainer 42 are formed as a disc with a tubular extension in the form of the respective centering part 46, 48 protruding from the disc into the hole 20. Axially extending centering part 46 defines fluid inlet 24 and axially extending centering part 48 defines central hole 44. Lid 34 also includes an axially extending centering part 49 protruding away from hole 20. Axially extending centering part 49 defines fluid outlet 26 and can be inserted into the fluid inlet 24 of another battery 10 as discussed further below.

The internal retainer 42 is electrically connected to the lid 32 and electrically connects a first lead 50 of the battery cell 12 to the lid 32. First lead 50 can be connected to internal retainer 42 and lid 32 by brazing, laser/ultrasonic welding, or clinching. The first lead 50 can be positive and can be formed by a cable including a wire. First lead 50 extends from the cathode 16 through the seam 28a of housing 28 to the retainer 42. As shown in FIG. 1, the lid 32 includes recessed sections 32a and raised sections 32b that alternate with each other. Recessed sections 32a define contact sections that contact internal retainer 42 to physically and electrically connect lid 32 to internal retainer 42. Raised sections 32b define fluid flow channels 52 within container 22 for fluid to flow from hole 20 to tubular space 40. First longitudinal end 12c of battery cell 12 is sealingly fixed to radially extending section 36 of can 30 by adhesive 53 and second longitudinal end 12d of battery cell 12 is sealingly fixed to internal retainer 42 by adhesive 53 to prevent fluid from flowing between first longitudinal end 12c and fluid outlet 26 or between second longitudinal end 12d and internal retainer 42 so that gas pressure cannot be used to compress the battery cell 12 in the axial direction. The fluid receiving spaces of battery 10 provide a chamber built into the container 22, such that a static pressure of the fluid reacts against both the inner circumferential surface 12a and outer circumferential surface 12b of battery cell 12 to form a uniform pressure on the cell 12, which promotes proper solid-state cell function.

The can 30 is electrically connected to a second lead 54 of the battery cell 12. The second lead 54 can be negative and can be formed by a cable including a wire. Second lead 54 extends from the anode 14 through the seam 28a of the housing 28 to an electrically conductive ring 56, which is connected to inner circumferential surface 34a of tubular section 34 and electrically connects second lead 54 to can 30. Second lead 54 can be connected to ring 56 by brazing, laser/ultrasonic welding, soldering, projection welding, spot welding or clinching. The electrically conductive ring 56 can be attached to the can 30 and retained using a rolling process to lock the ring 56 into place around the perimeter.

Lid 32 and can 30 are electrically insulated from each other by a flexible seal 58 surrounding an outer circumference of lid 32. Lid 32 can define a positive terminal of battery 10 and radially extending section 36 of can 30 can define a negative terminal of battery 10.

A method of constructing a battery 10 including inserting a tubular battery cell 12 into an open end 30a of a can 30 such a tubular space 40 is present between an outer circumferential surface 12b of the battery cell 12 and an inner circumferential surface 34a of the can 30 and a first longitudinal end 12c of the battery cell 12 faces radially extending end section 36 of the can 30. The method of constructing a battery 10 also includes installing the internal retainer 42 onto a second longitudinal end 12d of the battery cell 12 and connecting a lid 32 to the open end of the can 30 such that the lid 32 is electrically connected to the internal retainer 42 during operation of the battery 10.

FIG. 6 shows a battery assembly 100 including a plurality of batteries 10 connected together. The central through holes 28 of the at least two batteries 10 are aligned with each other and the fluid inlet 24 of at least one of the one of the batteries 10 is connected to the fluid outlet 26 of another of the batteries 10. In the example shown in FIG. 6, four batteries 10 are shown, but it should be understood that such a battery system can include tens or hundreds of batteries 10. FIG. 6 shows two sets of batteries 10, with the two batteries in the top of the figure forming a first set and the two batteries in the bottom of the figure forming a second set. Each set includes two batteries 10 arranged in series both from a fluid flow relationship and an electrical relationship. Each of the upstream batteries 10 on the right side of FIG. 6 are aligned with one of the downstream batteries 10 on the left side of FIG. 6.

For each battery set, the fluid outlet 26 of one battery 10 is directly connected to the fluid inlet 24 of the other battery 10 and the lid 32 of one battery 10 is engaged with the radially extending section 36 of the other battery. More specifically, for each battery set, the axially extending centering part 49 of the lid 32 of one battery 10 is inserted into the axially extending centering part 46 of radially extending section 36 of the other battery 10. Thus, fluid can flow into an inlet 24 of the first battery 10, through the hole 20 of the first battery 10, and then out of the fluid outlet 26 of the first battery directly into inlet 24 of the second battery 10, through the hole 20 of the second battery 10, and then out of the fluid outlet 26 of the second battery.

The two sets of batteries can also be electrically connected together in parallel by a parallel connection 160. The parallel connection 160 contacts the positive terminals of the batteries on the right side of the figure and the negative terminals of the batteries on the right side of the terminal to electrically connect the first and second sets in parallel.

FIG. 7 shows a system 200 for providing compressed and heated fluid to the battery assembly 100. System 200 is configured for conveying heated compressed gas into the batteries 10 of battery assembly 100 to provide constant pressure to batteries 10 during the charging and discharging in order to provide sufficient ionic conductivity between the anode material and the cathode material, and to maintain the operating temperature within the range of acceptable operating temperatures.

System 200 is configured for conveying compressed gas into batteries 10 via the fluid inlet 24 to generate a force on the cells 12 for maintaining uniform pressure on each battery cell 12. The system 200 includes a gas inlet line 202 feeding into the fluid inlets 24 of upstream batteries 10 and a gas outlet line 204 for gas exiting the fluid outlets 26 of the downstream batteries 10.

System 200 further includes a controller 206 configured to control a flow rate of heated compressed gas to batteries 10 to control the temperature within pressure batteries 10 and configured to control a pressure within the batteries 10 to maintain uniform pressure on each battery 10. More specifically, system 200 includes a control valve 208 in gas inlet line 202 and a pressure relief valve 210 in gas outlet line 204. Controller 206 is configured to control a flow rate of heated compressed gas to batteries 10 by sending control signals to control valve 208 and to control the pressure within the batteries 10 by sending control signals to pressure relief valve 210. Pressure relief valve 210 also maintains the pressure of the batteries 10 when the vehicle is shut off. The system 200 includes a check valve 212 in the gas inlet line 202 for allowing compressed gas to flow into the fluid inlets 24 of upstream batteries 10 and preventing backflow from the fluid inlets 24 of upstream batteries 10.

System 200 can be onboard a motor vehicle and further include an HVAC system 214 configured for absorbing heat from a cabin of the motor vehicle and producing heated compressed gas that is supplied to system 200. The heated compressed gas can advantageously be carbon dioxide. The HVAC system 214 includes an evaporator 216 within the cabin of the motor vehicle configured for absorbing heat from the cabin and evaporating liquid refrigerant into gas. HVAC system 214 further includes a compressor 218 configured for compressing and heating the gas, and a condenser 220 configured for cooling the heated compressed output by the compressor and condensing the gas into a liquid.

The control valve 208 is provided directly downstream of compressor 218 and is configured for directing the heat compressed output by the compressor 218 to fluid inlets 24 of the upstream batteries 10 and/or to the condenser 220. The heated compressed gas can thus be directed to fluid inlets 24 of the upstream batteries 10 through the check valve 52 and into batteries 10 to heat the battery cells 12 and pressurize batteries 10 to maintain sufficient contact between the battery cells 12.

The gas exiting from the fluid outlets 26 of the downstream batteries 10 of assembly 100 flows through pressure relief valve 210 to merge with the liquid refrigerant output by condenser 220. The HVAC system 214 further includes a dryer 222 downstream from the pressure relief valve and configured for receiving liquid refrigerant from condenser 220, which has merged with the gas exiting from the fluid outlets 26 of the downstream batteries 10 of assembly 100. An expansion valve 224 of HVAC system 214 is downstream of the dryer 222 for regulating the flow of liquid refrigerant into evaporator 216.

### LIST OF REFERENCE CHARACTERS

10 batteries
12 battery cell
12a inner circumferential surface
12b outer circumferential surface
12c first longitudinal end
12d second longitudinal end
13 separator material
14 anode
14a anode material
14b anode current collector foil
16 cathode
16a cathode current collector foil
16b cathode material
18 solid electrolyte
20 hole
22 container
24 fluid inlet
26 fluid outlet
28 flexible housing
28a seam
29a internal shell
29b external shell
30 can
30a open end
32 lid
32a recessed sections
32b raised sections
34 tubular section
34a inner circumferential surface
36 radially extending section
40 tubular space
42 internal retainer
44 central hole
46 axially extending centering part
48 axially extending centering part
49 axially extending centering part
50 first lead
52 fluid flow channels
54 second lead
56 electrically conductive ring
58 flexible seal
100 battery assembly
160 parallel connection
200 system
202 gas inlet line
204 gas outlet line
206 controller
208 control valve
210 pressure relief valve
212 check valve
214 HVAC system
216 evaporator
218 compressor
220 condenser
222 dryer
224 expansion valve

What is claimed is:

1. A battery comprising:
a tubular battery cell including an anode, a cathode and a solid electrolyte, the battery cell defining a central through hole; and
a container, the battery cell being inside of the container, the container including a fluid inlet configured to provide fluid to the central through hole and a fluid outlet configured to receive fluid from the central through hole.

2. The battery as recited in claim 1 wherein the battery cell has a jelly roll configuration.

3. The battery as recited in claim 1 further comprising a flexible housing inside the container surrounding the battery cell, the flexible housing configured for allowing the battery cell to radially expand and contract within the flexible housing.

4. The battery as recited in claim 3, wherein the flexible housing is a bag including an internal polypropylene shell formed of a first polymer and an external shell formed of a second polymer.

5. The battery as recited in claim 3, wherein the flexible housing is oversized with respect to the battery cell to allow for up to 10% expansion of the battery cell during charge and/or discharge of the battery cell.

6. The battery as recited in claim 1 wherein an outer circumferential surface of the battery cell and an inner circumferential surface of a tubular section of the container define a tubular space therebetween to allow gas to flow outside of the outer circumferential surface of the battery cell to generate a radially inward force on the outer circumferential surface of the battery cell.

7. The battery as recited in claim 6 further comprising an internal retainer inside the container and fixed to a first longitudinal end of the battery cell, the internal retainer including a central hole therein aligned with the central through hole of the battery cell to cause fluid flowing from the fluid inlet to the fluid outlet to pass through the central hole of the internal retainer.

8. The battery as recited in claim 7 wherein the container includes a can and a lid fixed to the can, the can including the tubular section, the internal retainer being physically connected to the lid and held in place within the can by the lid.

9. The battery as recited in claim 8 wherein a radially extending section of the can defines a first longitudinal end of the container and the lid defines a second longitudinal end of the container, the lid including the fluid outlet, the radially extending section of the can including the fluid inlet.

10. The battery as recited in claim 8 wherein the radially extending section of the can includes an axially extending centering part protruding into the central through hole of the battery cell at a first longitudinal end of the battery cell.

11. The battery as recited in claim 10 wherein the internal retainer includes an axially extending centering part protruding into the central through hole of the battery cell at a second longitudinal end of the battery cell.

12. The battery as recited in claim 8 wherein the internal retainer is electrically connected to the lid and electrically connects a first lead of the battery cell to the lid.

13. The battery as recited in claim 12 wherein the can is electrically connected to a second lead of the battery cell.

14. The battery as recited in claim 13 wherein the first lead is positive and the second lead is negative.

15. The battery as recited in claim 8 wherein the lid is configured to provide fluid flow channels between the lid and the internal retainer for fluid to pass from the central through hole of the battery cell to the tubular space.

16. A battery assembly comprising:
at least two of batteries as recited in claim 1, at least one of the batteries being an upstream battery with respect to a fluid flow and at least one of the batteries being a downstream battery with respect to the fluid flow; and
the central through holes of the at least upstream battery and the at least one downstream battery being aligned with each other and the fluid inlet of one of the at least one downstream battery being connected to the fluid outlet of the at least upstream battery.

17. A battery system comprising:
the battery assembly as recited in claim 16; and
a pressurization system for conveying compressed gas into the batteries to generate a force on the battery cells for maintaining uniform pressure on each battery cell.

18. A method of constructing a battery comprising:
inserting a tubular battery cell into an open end of a can such a tubular space is present between an outer circumferential surface of the battery cell and an inner circumferential surface of the can, a first longitudinal end of the battery cell facing a radially extending end section of the can, the radially extending end section of the can including a fluid inlet configured to provide fluid to a central through hole of the battery cell, the battery cell including an anode, a cathode and a solid electrolyte;
installing an internal retainer onto a second longitudinal end of the battery cell; and
connecting a lid to the open end of the can such that the lid is electrically connected to the internal retainer during operation of the battery, the lid including a fluid outlet configured to receive fluid from the central through hole.
